(19) United States
(12) Patent Application Publication
(10) Pub. No.: US 2021/0362166 A1
(43) Pub. Date: Nov. 25, 2021

(54) SEPARATING MILK

(71) Applicant: Tetra Laval Holdings & Finance S.A., Pully (CH)

(72) Inventor: Rolf MÅNSSON, Vaxjo (SE)

(21) Appl. No.: 16/772,462

(22) PCT Filed: Dec. 14, 2018
(86) PCT No.: PCT/EP2018/085040

§ 371 Date: Jun. 12, 2020

(30) Foreign Application Priority Data
Dec. 19, 2017 (EP) 17208513.6

(51) Int. Cl. B04B 7/14; B04B 1/08

(52) U.S. Cl. CPC B04B 7/14; B04B 1/08

(57) ABSTRACT

A method is provided for separating milk at least into a milk phase and a cream phase, including supplying the milk to an inlet of a centrifugal separator that comprises a stack of discs that has a first sub-stack that includes microorganism clarification discs, and a second sub-stack that includes milk-fat separation discs. The flow of milk is distributed through and over the first and second sub-stacks, which have through openings that are aligned with each other, such that at least one common distribution channel is formed through the first and second sub-stacks. A centrifugal separator is also provided.

### TECHNICAL FIELD

The invention relates to milk separation, and especially to milk separation using centrifugal centrifugation.

### BACKGROUND

Within the food processing industry centrifugal separation is widely used for separation of liquids or for separation of solids from liquids. Separation is achieved by introducing the liquid to be processed in a rotating bowl and collecting separated phases e.g. by means of different outlets arranged at the periphery of the bowl and close to the rotational axis.

Centrifugal separation is widely used in the food industry, e.g. for separation and clarification of milk, whey and juices. The separation of raw milk into a cream phase and a skim milk phase is called milk skimming, in which milk is subjected to a high centrifugal force in the rotating bowl of the centrifugal separator. A skim milk fraction, having higher density than a cram fraction, moves between separation discs towards the periphery of the rotating bowl, whereas the fat globules of the cream fraction are forced towards the rotational axis due to the incoming, un-separated milk. Thus, there are two outlets in a milk skimming, centrifugal separator, one for the skim milk phase and the other for cream phase.

Milk may further be contaminated with different types of micro-organisms when it leaves the udder. Due to their higher density, microorganisms may be separated from milk by means of centrifugation in a special centrifuge, often referred to as bactofugation separator, or bactofuge. In the disc stack of a bactofugation separator, the milk is separated into a light phase, with low concentration of micro-organisms, called “clean milk” and a heavy phase with spores and bacteria. The heavy phase is collected in a so called sediment space at the periphery of the bowl, which is emptied accurately at preset intervals.

In today's standard processes where a bactofugation separator, milk is first skimmed in a milk skimming, centrifugal separator and is then then a second centrifuge is installed to bactofugate the skimmed/standardized milk. The surplus cream phase provided from the skimming does not pass the bactofugation separator. To achieve a bacteria reduction also in the surplus cream, the whole milk must pass the bactofugation separator prior to fat separation (milk skimming). To achieve this a clarification separation step, i.e. a course filtration, of the whole milk must be performed in order to remove foreign particles from the whole milk. Otherwise, such particles may interfere with the performance of the bactofugation separator, e.g. by plugging parts of the rotating bowl.

As the industrial processing of milk increases, the processes and equipment becomes more and more sensitive to the quality of the material that is processed. As discussed above, three different separator may be used to achieve satisfying removal of particles, bacteria as well as milk skimming of the whole milk.

There is thus a need in the art for more efficient and cost-effective processes and equipment to process milk.

### SUMMARY

It is an object of the invention to at least partly overcome one or more limitations of the prior art.

In particular, it is an object to provide a method and a single centrifugal separator that may achieve satisfying clarification of the milk from particles and bacteria as well as separation of milk into a milk phase and a cream phase.

In one aspect of the invention, this is achieved by a method for separating milk (A) at least into a milk phase (B) and a cream phase (C), the method comprising the steps of:

supplying the milk to an inlet of a centrifugal separator, the separator comprising a frame and a drive member configured to rotate a rotating part in relation to the frame around an axis of rotation (X), a first outlet for discharging a milk phase and a second outlet for discharging a cream phase, wherein the rotating part comprises a centrifuge rotor enclosing a separation chamber arranged to receive the supply of milk via the inlet and comprising a stack of discs that has a first sub-stack that comprises microorganism clarification discs, and a second sub-stack that comprises milk-fat separation discs,

distributing the flow of milk through and over the first sub-stack, the microorganism clarification discs having through openings that are arranged at a radial distance (R1) from the axis of rotation (X),

distributing the flow of milk through and over the second sub-stack, the milk-fat separation discs having through openings that are aligned with the through openings of the microorganism clarification discs, such that at least one common distribution channel is formed through the first and second sub-stacks,

discharging a milk phase via the first outlet, and

discharging a cream phase via the second outlet.

The step of supplying mil to be separated may of course also comprise rotating the rotating part of the centrifugal separator, e.g. at its operational speed.

The method is based on the insight that milk skimming separators, i.e. separators that separate fat from milk, working together with separators for removing microorganisms, e.g. bactofugation separators, may often separate out more fat than necessary for fat-standardized milk products such as cheese milk, pasteurized milk and aseptic products.

The method is thus advantageous in that it combines clarification, fat separation and bacteriological removal in one and the same separator. This is due to the disc stack being divided into two sub-sets. A first sub-set of the stack of separation discs comprises microorganism clarification discs that allows for removal of microorganisms and a second subset comprises milk-fat separation discs which allows for separation of the milk into a cream phase and a milk phase. Thus, the idea is to achieve high removal of bacteria in combination with a good-enough separation of milk into a cream phase and a milk phase in the centrifugal separator. This means that both the discharged milk phase as well as the discharged cream phase has been subjected to a step of removal of microorganisms.

Microorganism clarification discs are separation discs suitable for the removal of microorganisms. The distance members, i.e. the members forming the gap between two adjacent disc a stack of separation discs, of microorganism clarification discs may be arranged so as to reduce tangential flow, i.e. a circumferential flow, in the gap between two discs. Such distance-members may thus extend in the radial direction a distance that is at least 25% of the radius of the disc.

Milk-fat separation discs are separation discs suitable for the separation of milk into a cream phase and a milk phase. The distance members of milk-fat separation discs may be arranged so as to allow for a tangential flow, i.e. a circumferential flow, in the gap between two discs and e.g. be formed as spots on the surface of a milk-fat separation disc.

In embodiments, discharged milk phase has a fat content of between 0.1% to 3.0%.

Such fat contents may be useful when the discharged milk phase is to be used in end-products comprising milk having a standardized fat content.

In embodiments, the distribution of the flow of milk through and over the first and second sub-stacks reduces spore forming bacteria in the milk by 50% to 90%.

This is thus advantageous in that the method allows for both high removal of spore-forming bacteria as well as a satisfying removal of fat from the milk.

As a further aspect of the invention, there is provided method for producing milk,

comprising

separating milk (A) into at least into a milk phase (B) and a cream phase (C) by performing a method according to the first aspect,

mixing a milk phase and a cream phase to obtain a predetermined fat content of the milk, and

packing the milk in packages to be distributed to consumers.

In another aspect of the invention, there is provided a centrifugal separator for separating milk (A) at least into a milk phase (B) and a cream phase (C), the separator comprising

a frame and a drive member configured to rotate a rotating part in relation to the frame around an axis of rotation (X), a first outlet for discharging a milk phase and a second outlet for discharging a cream phase, wherein the rotating part comprises a centrifuge rotor enclosing a separation chamber arranged to receive the supply of milk via the inlet and comprising a stack of discs that has a first sub-stack that comprises microorganism clarification discs, and a second sub-stack that comprises milk-fat separation discs, wherein

the microorganism clarification discs having through openings that are arranged at a radial distance (R1) from the axis of rotation (X), and

the milk-fat separation discs having through openings that are aligned with the through openings of the microorganism clarification discs, such that at least one common distribution channel is formed through the first and second sub-stacks, and wherein

the number of microorganism clarification discs in the first sub-stack is larger than the number of milk-fat separation discs in the second sub-stack.

The centrifugal separator may thus be used in the method according to the first aspect above. The centrifugal separator may thus be used as a dual- or multi-purpose separator instead of using several separators in applications where e.g. there is a standardization of the fat content in the discharged milk phase.

Further, the centrifugal separator may further increase the overall removal of anaerobic spores, which in a traditional milk skimming separator is may be discharged together with the cream phase and hence do not pass any downstream bactofugation of the skim milk phase. In the separator of the present disclosure, the milk is instead subjected to removal of microorganisms, such as bactofugation, within the separator itself before the separation of fat, i.e. the discharged cream phase from the separator may have a low content of anaerobic spores in the cream phase.

The number of separation discs is the first sub-stack may be at least twice as many than the number of separation discs in the second sub-stack.

Still other objectives, features, aspects and advantages of the invention will appear from the following detailed description as well as from the drawings.

### DRAWINGS

Embodiments of the invention will now be described, by way of example, with reference to the accompanying schematic drawings.

FIG. 1 is a cross-sectional view of a centrifugal separator of the present disclosure.

FIG. 2 is a close-up view of the centrifugal separator of FIG. 1.

FIG. 3 is a side-view of a microorganism clarification disc.

FIG. 4 is a side-view of a milk-fat separation disc.

FIG. 5 schematically illustrates a method of the present disclosure.

### DETAILED DESCRIPTION

Embodiments of the invention will now be described more fully hereinafter with reference to the accompanying drawings, in which some, but not all, embodiments of the invention are shown. The invention may be embodied in many different forms and should not be construed as limited to the embodiments set forth herein.

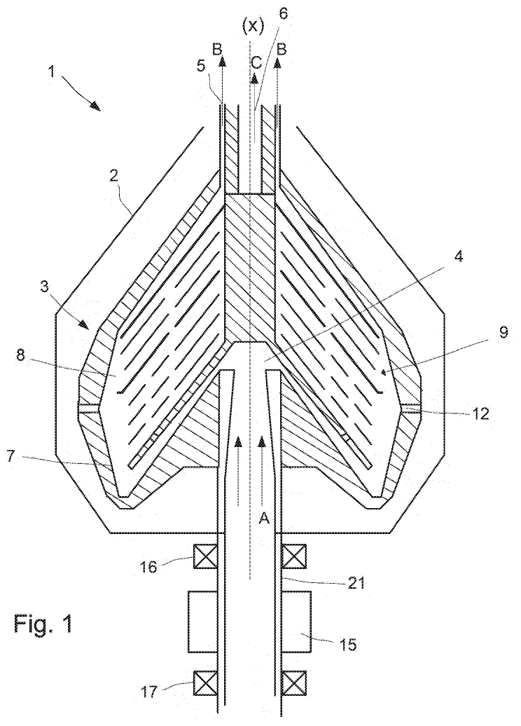

With reference to FIG. 1 an exemplary centrifugal separator 1 is illustrated. The centrifugal separator 1 is for separating milk into a milk phase (A) and a cream phase (B) and comprises a frame 2 and a drive member 15 configured to rotate a rotating part 3 in relation to the frame 2 around the axis of rotation (X). The rotating part 3 comprises a centrifuge rotor 7 enclosing a separation chamber 8. The rotating part 3 further comprises a hollow spindle 21 (partly shown) onto which the rotor 7 is arranged around an axis of rotation (x) by means of upper bearing 16 and lower bearing 17. Thus, the hollow spindle 21 is arranged to be rotated during operation of the centrifugal separator 1. During operation, the spindle 21 thus forms a rotating shaft.

A drive member 15 is arranged for transmitting torque to the spindle 21 and comprises an electrical motor having a rotor and a stator. Advantageously, the rotor of the electrical motor may be provided on or fixed to the spindle of the rotating part. Alternatively, the drive member may be provided beside the spindle and rotate the rotating part by a suitable transmission, such as a belt or a gear transmission.

The centrifuge rotor 7 encloses, or forms within itself, the separation chamber 8 in which a disc stack 18 is arranged and in which the centrifugal separation of the milk phase to takes place during operation.

The centrifugal separator 1 further comprises an inlet 4 for receiving the milk to be separated and the separation chamber 8 is thus arranged to receive the supply of milk via the inlet 4. The separator 1 is in this embodiment fed from the bottom via the spindle. However, it is to be understood that the centrifugal separator 1 may be arranged to be fed from the top, e.g. via a stationary inlet pipe that is arranged to supply the milk to be separated to the inlet 4. In such case, the inlet outlets could all be arranged at the top of the separator 1.

A first outlet 5 for discharging a milk phase and a second outlet 6 for discharging a cream phase is arranged on the upper part of the centrifugal separator. The first outlet 5 for discharging the separated milk phase is arranged on a larger radius than the outlet 6 for discharging the lighter cream phase. The second outlet 6 is arranged around the axis of rotation (X).

The inlet 4 and/or the first and second outlets 5,6 are mechanically hermetically sealed. This means that the centrifugal separator comprises mechanic seals (not shown) between the rotating part and the stationary part of the centrifugal separator that prevent or decrease the risk of air entering into the processed liquid. Consequently, the inlet 4 may be a hermetic inlet. A hermetic inlet is sealed from the surroundings of the rotor and is arranged to be filled with fluid product during operation. The hermetic inlet may maintain the quality of the milk by preventing air from entering the process. A mechanically hermetically sealed separator at the inlet and the outlets further provides for supplying the milk to be separated under pressure.

The centrifuge rotor 7 is further provided with outlets 12 arranged at the radially outer periphery of the separation chamber 8 for intermittent discharge of a sludge component of the milk. The opening of the outlets 12 is controlled by means of an operating slide (not shown) actuated e.g. by operating water, as known in the art.

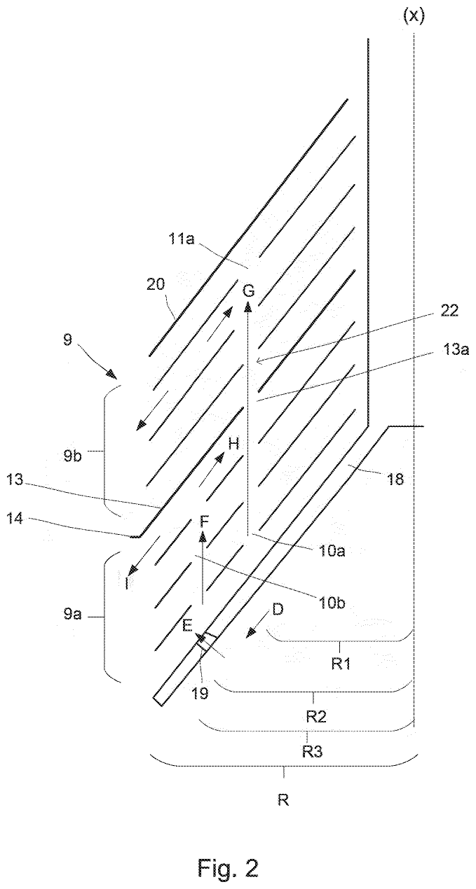

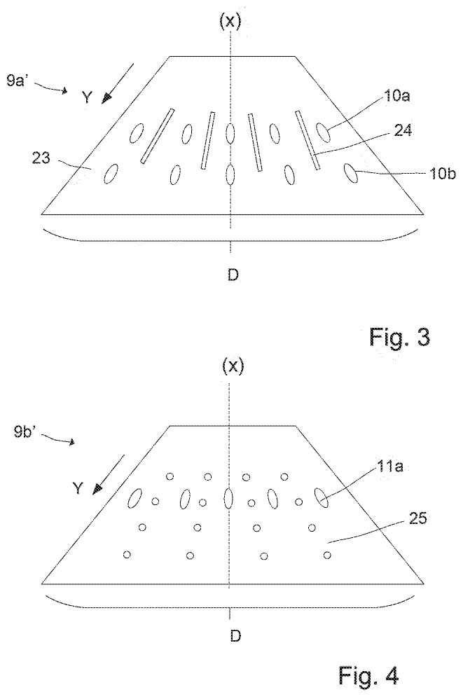

FIG. 2 further shows a close-up view of the stack 9 of separation discs arranged in the separation chamber 8. The stack 9 of separation discs arranged coaxially around the axis of rotation (X) at a distance from each other such as to form passages between each two adjacent separation discs. The first sub-stack 9a comprises microorganism clarification discs 9a″, and a second sub-stack 9b that comprises milk-fat separation discs 9b′. These discs are shown in more detail in FIGS. 3 and 4.

The microorganism clarification discs comprises through openings 10a that are arranged at a radial distance (R1) from the axis of rotation (X), and the milk-fat separation discs comprises through openings 11a that are aligned with the through openings 10b of the microorganism clarification discs, such that a common distribution channel 22 is formed through the first 9a and second 9b sub-stacks.

Further, the number of microorganism clarification discs in the first sub-stack 9a is larger than the number of milk-fat separation discs 9b′ in the second sub-stack 9b.

A through opening may be a hole through the surface of a separation disc or it may be a slit extending radially inwards from the outer periphery of a disc.

In this embodiment, the microorganism clarification discs 9a″ comprises inner through openings 10a as well as outer through openings 10b.

The inner through openings 10a may be arranged at a position that is more than 25% of the radius of the separation disc, such as at a position that is between 40-60% of the radius of the separation discs, such as about 50% of the radius of the separation disc. Consequently, if the radius of a separation disc is denoted R, then R1 may be more than 0.25*R, such as between 0.4-0.6*R, such as about 0.5*R.

The outer through openings 10b may be arranged at a position that is more than 50% of the radius of the separation disc, such as at a position that is between 80-95% of the radius of the separation disc, such as about 90% of the radius of the separation disc.

Consequently, R2 may be more than 0.50*R, such as between 0.8-0.95*R, such as about 0.9*R.

However, the outer through openings 10b may be slits extending from the outer periphery of a disc and radially inwards.

Consequently, the first sub-stack 9a comprises through openings both at an inner radial position (R1) and an outer radial position (R2), and the through openings 11b of the second sub-stack 9b are aligned with the through openings 10a of the first sub stack 9a arranged at the inner radial position (R1) so as to form a common distribution channel 22 through the first 9a and second 9b sub-stack.

Thus, milk to be separated may be axially distributed through and over the surfaces of the separation discs of both sub-stacks via common distribution channel 22 arranged at the inner radial position R1. The separation discs may comprise several through openings that form the common distribution channels 22. As an example, the first sub-stack may comprise at least four, such as at least six, through openings at inner radial position (R1) and the through openings 11b of the second sub-stack 9b may thus be aligned with the through openings 10a to form at least four, such as at least six, common distribution channels 22.

In FIG. 1 and FIG. 2, the distance between each separation disc is exaggerated for clarity. The whole stack 9 may comprise more than 50 separation discs, such as more than 100 separation discs, such as more than 150 separation discs.

The number of separation discs is the first sub-stack 9a may be at least twice as many than the number of separation discs in the second sub-stack 9b. As an example, the first sub-stack may comprise at least 20 more discs than the second sub-stack, such as at least 50 more discs than the second sub-stack, such as at least 80 more discs than the second sub stack. Thus, the centrifugal separator 1 comprises more microorganism clarification discs 9a″ than milk-fat separation discs 9b′.

As a further example, the first sub stack 9a may comprise 100-130 separation discs, whereas the second sub stack 9b may comprise less than half of the separation discs of the first sub stack 9a, such as between 30 and 60 separation discs.

As seen in FIG. 2, the disc stack 9 is arranged on a distributor 18 and the inlet 4 is form under or as channels/outtakes within the distributor. The inlet 4 communicates with the separation chamber and stack 9 via passages 19 formed in the distributor 18. The passages 19 are arranged in the distributor 18 so that milk to be separated is supplied at radius (R3) in the separation chamber 8 that is above half of the radius (R) of the stack 9 of separation discs.

The radially inner portion of the disc stack 9 further communicates with the second outlet 6 for the separated cream phase of the milk that is treated in the separator. The first outlet 5 for the separated milk phase is delimited by a top disc 20 provided at the upper axial end of the disc stack 9, i.e. separated milk phase flows over top disc 20 towards the first outlet 5. The top disc 20 and an outer wall part of the centrifuge rotor 7 may thus delimits a passage for the denser liquid component of the milk, the passage extending from the radially outer part of the separation chamber 8 to the first outlet 5 arranged at the top of the separator 1.

Furthermore, the second sub-stack 9b of separation discs is arranged downstream of the first sub-stack 9a, such that the distributing 104 of the flow of milk through and over the first sub-stack 9a takes place before the distributing 106 of the flow of milk through and over the second sub-stack 9b. In other words, the second sub stack 9b is arranged axially above the first sub stack 9a since the flow of milk enters separation chamber in it lower part. However, in embodiments, the stacks are arranged the other way around, i.e. so that the milk first enters the stack comprising the milk-fat separation discs 9b before entering the stack comprising the microorganism separation discs 9a.

The centrifugal separator 1 further comprises an intermediate disc 13 arranged between the first 9a and second 9b sub-stacks, and wherein the intermediate disc 13 comprises a brim portion 14 arranged radially outside the outer diameters (D) of the first 9a and second 9b sub-stacks and further comprises through openings 13a that are aligned with the through openings 10a, 11a of the microorganism clarification discs and the milk-fat separation discs.

Thus, the common distribution channel 22 is formed through the first 9a and second 9b sub-stacks as well as through the intermediate disc 13

The brim portion 14 is in this case flat, i.e. it has an angle of zero degrees to the radial direction. However, the brim 14 could also have the same angle as the intermediate disc 13 relative the radial direction.

The intermediate disc 13 may also have a larger thickness than the discs of the first 9a and second 9b sub stacks. As an example, the intermediate disc 13 may have a thickness that is twice the thickness of the discs of the first 9a and second 9b sub stacks.

FIG. 3 shows a schematic illustration of a microorganism clarification disc 9a′ comprising a number of inner through openings 10a and a number of outer through openings 10b. As discussed above, the outer through openings 10b could be arranged as slits at the outer periphery of the discs.

Each microorganism clarification disc 9a′ comprises a surface 23 that extends in a direction (Y) from a center of the stack 9 to a periphery of the stack 9.

The disc has a frustoconical shape with an inner and an outer separation surface. Surface 23 is in this case the outer surface of the disc.

Further, the microorganism clarification discs 9a′ comprise elongated distance members 24 that extend in the direction (Y) to reduce a tangential flow of milk through and over the first sub-stack 9a.

The distance members 24 are spacing members that provide a distance between each two adjacent separation discs a stack of separation discs, i.e. such that passages are formed between adjacent discs in the stack. The elongated distance members 24 could be formed as curved or straight radial caulks attached to the inner or outer surface 23 of a separation disc. The elongated distance members 24 may thus be continuous or have the form of spots that are aligned with each other in the radial direction.

FIG. 4 shows a schematic illustration of a milk-fat separation disc 9b′ comprising solely a number of inner through openings 11a, which are aligned with the through openings 10a of a microorganism clarification disc 9a′. The milk-fat separation disc 9b′ is similar to a microorganism clarification disc 9a′ in terms of size, thickness but the milk-fat separation discs 9b′ comprise distance members 25 that all are, as seen in the direction (Y), shorter than the elongated distance members 24 of the microorganism clarification discs.

The milk-fat separation discs 9b″ may thus allow for a tangential flow, i.e. a circumferentially directed flow, between two separation discs. The distance members 25 may be formed as small spots, i.e. be spot-shaped. The distance members 25 may further be continuous or have the form of spots that are aligned with each other in the radial direction.

In the embodiment shown in FIG. 4, the separation milk-fat separation disc comprises solely spot-shaped spacing members 25, but the milk-fat separation disc 9b″ may comprises a combination of spot-shaped and elongated spacing members.

The distance members 24 the microorganism separation discs 9a″ and the distance members 25 of the milk-fat separation disc 9b′ could be in the form of elements attached to the separation disc's conical portion surface portion 23 by means of, for example, soldering or welding.

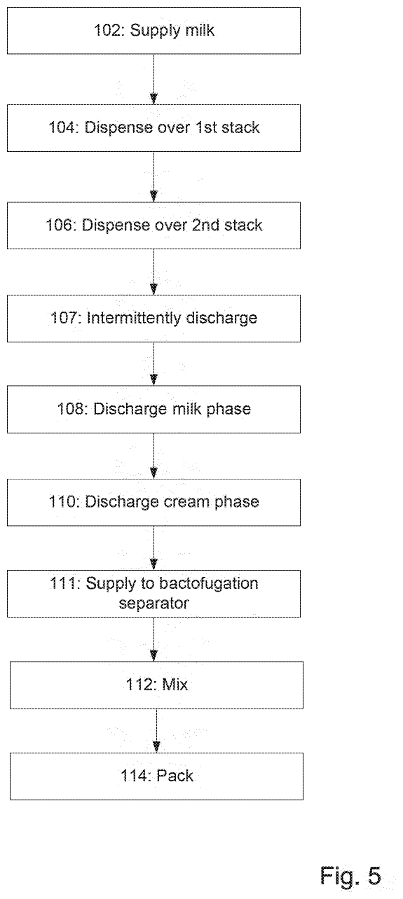

A method of the present disclosure is further illustrated in FIG. 5. During operation of the centrifugal separator 1 in FIGS. 1 and 2, the rotor 3 is caused to rotate by torque transmitted from the drive motor 15 to the spindle 21. Milk to be separated is brought into the inlet 4 via the hollow spindle 21, illustrated by arrow “A” in FIG. 1, and is further led via passages below or within the distributor 18 to the separation chamber 8, as illustrated by arrow “D” in FIG. 2. Thus, the method comprises the step of supplying 102 the milk to the inlet of a centrifugal separator. The method may consequently also comprise rotating the rotating part of the centrifugal separator, e.g. at its operational speed.

The milk may be hot milk, e.g. supplied at a rate of between 7 000-75 000 l/h or cold milk, e.g. supplied at a rate of 10 000 to 50 000 l/h.

Due to the position of the passages 19 in the distributor, supplying 102 of milk comprises introducing the milk supplied to the inlet 4 at a radius R3 in the separation chamber 8 that is above half of the radius R of the stack 9 of separation discs.

Milk may thus be transported axially upwards outside or in the outer part of the first sub-stack 9a. This allows for larger particles to be separated out from the milk due to the high centrifugal force, as illustrated by arrows “I” in FIG. 2, with little risk for the larger particles to clog the first sub-stack 9a. The inner through openings 10a and the outer through openings 10b of the first sub-stack forces the milk upwards and inwards through the first sub-stack 9a as illustrated by arrow “F”, which thus function as microorganism clarification discs, such as bactofugation separation discs. Hence, microorganisms, such as anaerobic spores, being the heavier component in the milk move radially outwards between the separation discs in the first sub-stack 9a, whereas the milk is forced radially inwards between the separation discs in the first sub-stack 9a.

Consequently, the method comprises distributing 104 the flow of milk through and over the first sub-stack 9a, the microorganism clarification discs having through openings 10a that are arranged at a radial distance R1 from the axis of rotation (X).

Due to the thicker intermediate disc 13, and its brim portion 14, there is a pressure drop that decreases the risk of microorganisms and other particles in the milk being led via through openings 13a into the second sub-stack 9b. Instead, mostly milk is led inwards under intermediate disc 13 to through openings 13a, as illustrated by arrow “H” in FIG. 2 to the second sub-stack 9b.

In the second sub-stack 9b, milk is led upwards via through openings 11a, which are axially and radially aligned with the inner through openings 10a of the first sub stack 9a and the through openings 13 of the intermediate disc. Fat is separated out from the milk in the second sub-stack 9b between the separation discs of the second sub stack 9b, which thus function as a stack of separation discs in a traditional milk separator. However, the milk separated in the second sub-stack may not be completely free of fat, but may have a fat content that at least is less than the fat content used in the product in which the milk phase (heavy phase) is to be used. The separated milk phase is led to a passage over the top disc 20 and forced out through first outlet 5 that is at a radial distance that is larger than the radial level of the second outlet 6 for the separated cream phase.

Consequently the method comprises distributing 106 the flow of milk through and over the second sub-stack 9b, the milk-fat separation discs having through openings 11a that are aligned with the through openings 10b of the microorganism clarification discs, such that at least one common distribution channel 22 is formed through the first 9a and second 9b sub-stacks.

In this example, the step of distributing 104 the flow of milk through and over the first sub-stack 9a is performed before the step of distributing 106 the flow of milk through and over the second sub-stack 9b. However, it is to be understood that the sub-stacks 9a and 9b may be arranged the other way around, i.e. so that the first sub-stack 9a comprising the microorganism clarification discs is arranged downstream milk-fat separation discs. Thus, the step of distributing 106 the flow of milk through and over the second sub-stack 9b may then be performed before the step of distributing 104 the flow of milk through and over the first sub-stack 9a.

Furthermore, the method of the disclosure further comprises discharging 108 a milk phase via the first outlet 5, and discharging 110 a cream phase via the second outlet 6.

Separated bacteria accumulate at the periphery of the separation chamber 8 and is emptied intermittently from the separation chamber 8 by the sludge outlets 12 being opened, whereupon a solid phase and a certain amount of fluid is discharged from the separation chamber 8 due to the centrifugal force. However, the discharge of a solid phase may also take place continuously, in which case the sludge outlets 12 take the form of open nozzles and a certain flow of sludge and/or heavy phase is discharged continuously by means of centrifugal force. Thus, the method may comprise intermittently discharging 107 a sediment phase via outlets 12 arranged at the periphery of the centrifuge rotor 7.

Due to the function of the centrifugal separator and its two different sub-stacks 9a and 9b, the discharged milk phase has a fat content of between 0.1% to 3.0%.

Furthermore, due to the function of the centrifugal separator and its two different sub-stacks 9a and 9b, distribution of the flow of milk through and over the first 9a and second 9b sub-stacks reduces spore forming bacteria in the milk by 50% to 90%.

The method may comprise further treatment of the discharged milk phase and/or the discharged cream phase, such as further treatment to lower the concentration of microorganisms.

Consequently, the method may comprise a further step supplying 111 the discharged milk phase to a bactofugation separator to further reduce the amount of microorganisms in the milk phase.

The bactofugation separator may be for the removal of microorganisms. As an example, a bactofugation separator may comprise a plurality of clarification discs 9a″ as described herein above or may comprise a stack of separation discs consisting solely of microorganism clarification discs 9a″, e.g. as described herein above.

With such a further reduction of microorganism, a total reduction of 99% or above may be achieved.

The separated milk phase may be used for dairy product having a standardized fat content.

Thus, the present disclosure provides a method for producing milk, comprising

separating milk (A) into at least into a milk phase (B) and a cream phase (C) by performing a method described herein above,

mixing 112 a milk phase and a cream phase to obtain a predetermined fat content of the milk, and

packing 114 the milk in packages to be distributed to consumers.

The invention is not limited to the orientation of the axis of rotation (X) disclosed in the figures. The term “centrifugal separator” also comprises centrifugal separators with a substantially horizontally oriented axis of rotation.

From the description above follows that, although various embodiments of the invention have been described and shown, the invention is not restricted thereto, but may also be embodied in other ways within the scope of the subject-matter defined in the following claims.

1. A method for separating milk at least into a milk phase and a cream phase, the method comprising the steps of:
supplying the milk to an inlet of a centrifugal separator, the separator comprising a frame and a drive member configured to rotate a rotating part in relation to the frame around an axis of rotation, a first outlet for discharging a milk phase and a second outlet for discharging a cream phase, wherein the rotating part comprises a centrifuge rotor enclosing a separation chamber arranged to receive the supply of milk via the inlet and comprising a stack of discs that has a first sub-stack that comprises microorganism clarification discs, and a second sub-stack that comprises milk-fat separation discs,
distributing the flow of milk through and over the first sub-stack, the microorganism clarification discs having through openings that are arranged at a radial distance from the axis of rotation,
distributing the flow of milk through and over the second sub-stack, the milk-fat separation discs having through openings that are aligned with the through openings of the microorganism clarification discs, such that at least one common distribution channel is formed through the first and second sub-stacks,
discharging a milk phase via the first outlet, and
discharging a cream phase via the second outlet.

2. The method according to claim 1, wherein the discharged milk phase has a fat content of between 0.1% to 3.0%.

3. The method according to claim 1, wherein the distribution of the flow of milk through and over the first and second sub-stacks reduces spore forming bacteria in the milk by 50% to 90%.

4. The method according to claim 1, wherein the supplying of milk comprises introducing the milk supplied to the inlet at a radius in the separation chamber that is above half of the radius of the stack of separation discs.

5. The method according to claim 1, comprising
intermittently discharging a sediment phase via outlets arranged at the periphery of the centrifuge rotor.

6. The method according to claim 1, comprising
supplying the discharged milk phase to a bactofugation separator to further reduce the amount of microorganisms in the milk phase.

7. The method according to claim 1, wherein
the stack of separation discs comprises an intermediate disc arranged between the first and second sub-stacks, and
the intermediate disc comprises
a brim portion arranged radially outside the outer diameters of the first and second sub-stacks, and
through openings that are aligned with the through openings of the microorganism clarification discs and the milk-fat separation discs.

8. The method according to any previous claim 1, wherein the second sub-stack of separation discs is arranged downstream of the first sub-stack, such that the distributing of the flow of milk through and over the first sub-stack takes place before the distributing of the flow of milk through and over the second sub-stack.

9. The method according to claim 1, wherein
each disc in the stack of discs comprises a surface that extends in a direction from a center of the stack to a periphery of the stack,
the microorganism clarification discs comprise elongated distance members that extend in the direction to reduce a tangential flow of milk through and over the first sub-stack, and
the milk-fat separation discs comprise distance members that are, as seen in the direction, shorter than the elongated distance members of the microorganism clarification discs.

10. The method according to claim 1, wherein
the first sub-stack comprises through openings both at an inner radial position and an outer radial positioner, and
the through openings of the second sub-stack that are aligned with the through openings of the first sub stack are arranged at the inner radial position so as to form the common distribution channel.

11. The method according to claim 1, wherein
the rotating part of the centrifugal separator comprises a hollow spindle on which the centrifuge rotor is arranged, and
the supplying of the milk to the inlet comprises supplying the milk to the inlet via the hollow spindle.

12. A method for producing milk, comprising
separating milk into at least into a milk phase and a cream phase by performing the method according to claim 1,
mixing a milk phase and a cream phase to obtain a predetermined fat content of the milk, and
packing the milk in packages to be distributed to consumers.

13. A centrifugal separator for separating milk at least into a milk phase and a cream phase, the separator comprising
a frame and a drive member configured to rotate a rotating part in relation to the frame around an axis of rotation, a first outlet for discharging a milk phase and a second outlet for discharging a cream phase, wherein the rotating part comprises a centrifuge rotor enclosing a separation chamber arranged to receive the supply of milk via the inlet and comprising a stack of discs that has a first sub-stack that comprises microorganism clarification discs, and a second sub-stack that comprises milk-fat separation discs,
the microorganism clarification discs having through openings that are arranged at a radial distance from the axis of rotation,
the milk-fat separation discs having through openings that are aligned with the through openings of the microorganism clarification discs, such that at least one common distribution channel is formed through the first and second sub-stacks, and wherein
the number of microorganism clarification discs in the first sub-stack is larger than the number of milk-fat separation discs in the second sub-stack.

14. The centrifugal separator according to claim 13, wherein
the stack of separation discs comprises an intermediate disc arranged between the first and second sub-stacks, and
the intermediate disc comprises
a brim portion arranged radially outside the outer diameters of the first and second sub-stacks, and
through openings that are aligned with the through openings of the microorganism clarification discs and the milk-fat separation discs.

15. The centrifugal separator according to claim 13, wherein the second sub-stack of separation discs is arranged downstream of the first sub-stack so that the milk is distributed through and over the first sub-stack before being distributed through and over the second sub-stack.
